(19) United States
(12) Patent Application Publication
(10) Pub. No.: US 2009/0029159 A1
(43) Pub. Date: Jan. 29, 2009

(54) Reduction of Label Curl

(76) Inventor: Liping Guo, Milwaukee, WI (US)

Correspondence Address: WHYTE HIRSCHBOECK DUDEK S C;INTELLECTUAL PROPERTY DEPARTMENT, 555 EAST WELLS STREET, SUITE 1900, MILWAUKEE, WI, 53202, US

(21) Appl. No.: 11/829,265

(22) Filed: Jul. 27, 2007

(51) Int. Cl. B32B 7/12

(52) U.S. Cl. 428/354

(57) ABSTRACT

A high-heat, curl-resistant thin label is described, the label comprising:
A. A film, e.g., polyester or polyimide film, having first and second facial surfaces;
B. A crosslinked, printable coating, e.g., a phenoxy resin coating, in intimate contact with or near one of the facial surfaces of the film, the coating comprising either high surface area filler, e.g., silica or mica, or a thermoplastic elastomer, e.g., a polyether or polyester type of polyurethane; and
C. A pressure-sensitive adhesive in intimate contact with or near the other facial surface of the film.

### FIELD OF THE INVENTION

This invention relates to labels. In one aspect, the invention relates to thin labels while in another aspect, the invention relates to thin labels comprising a coated film. In still another aspect, the invention relates to thin labels bearing a crosslinked top coating while yet in another aspect, the invention relates to thin labels in which the crosslinked top coating comprises a stress-relieving agent.

### BACKGROUND OF THE INVENTION

Thin labels have many applications typical of which are as identifiers for various parts in manufacturing operations. For example, the electronic components, e.g., microchips, resistors, capacitors, batteries, etc., and circuit boards of many electronic goods each bear a label with a serial number, bar code or other identifying indicia. These labels usually are delivered to a manufacturer on a roll from which they are robotically picked and placed onto a component moving within a continuous, often fast paced, assembly line. The design of the component and the robotic pick and place equipment is often such that the label must be flat, i.e., with little, if any, curl, to avoid jamming the equipment or misplacement of the label on the component, and to ensure complete edge-to-edge adhesion of the label to the component.

The typical construction of a thin label is a thin film, sometimes referred to as a base film or facesheet, with a coating on one facial surface of the film and an adhesive on the opposing facial surface. The adhesive, in turn, is often covered with a protective release liner that is removed at the time the label is applied to an object. FIG. 1 is illustrative. Thin label 10 comprises facesheet 11 with topcoat 12 on one facial surface and adhesive 13 on the opposing facial surface. Adhesive 13 is covered with protective release liner 14. Other layers (not shown) can be included above and below the facesheet, and these additional layers can be adjacent to or removed from the facesheet.

Curl is typically imparted to a thin label through the drying or crosslinking of the topcoat. The topcoat is typically applied to one facial surface of the film in a wet state, i.e., suspended or dissolved in a solvent. As the solvent evaporates, the coating solidifies and attaches to the film. After solidification and adhesion to the film is attained, solvent evaporation continues, and the coating continues to crosslink. As the coating dries and crosslinks, it shrinks isotropically, i.e., three-dimensionally, but because the underlying film does not shrink or shrinks less, the crosslinked coating causes the film to curl in the direction of the topcoat. The extent or degree of curl is a result of many factors including, but not limited to, the size of the label, the chemical composition of the coating and degree of crosslinking, the chemical composition of the film, the thickness of the coating relative to the film, and the like. Curl can cause difficulties in auto-dispensing the label on an assembly line, and it can cause or exacerbate label edge lifting upon exposure to high temperature.

Various methods have been proposed and/or implemented to counter-act thin film curl. One method is to change the formulation of the coating layer but since virtually all top coatings crosslink and/or dry, the coating inherently shrinks to one degree or another. Another method is to increase the thickness of the film such that the force generated on the film from the shrinkage of the coating is less than the force necessary to make the film curl. This method, however, works against the desire to make the label as thin as practical, and generally creates a film much thicker than commercially practical.

The common method for inhibiting curl is to apply an anti-curl back coating to the film sufficient to offset the curl imparted to the film due to the shrinkage of the coating. U.S. Pat. No. 4,223,062 teaches a method of reducing the curl in a thin film label by applying a methyl methacrylate (MMA) polymer to one side of the film while the other side of the film carries a lamination of a light transmissive coating, primer and photoplastic layer. The thickness of the MMA polymer layer is balanced against the thickness of the photoplastic layer. U.S. Pat. No. 6,261,730 teaches a flexible, electrostatographic imaging member comprising (i) a photographic imaging layer, (ii) a support layer, and (iii) a crosslinked, phenoxy resin at the exposed surface. The difficulty with these and other similar approaches is that it requires an additional layer, and this adds to both the expense of making the label and the thickness of the label.

The label industry has a continuing interest in the development of a multi-layer, thin label that is constructed of conventional materials and resists curling upon the crosslinking of the top coat without the requirement of adding an additional layer to the label.

### SUMMARY OF THE INVENTION

In one embodiment, the invention is a high-heat, curl-resistant thin label comprising:

A. A film having first and second facial surfaces;

B. A crosslinked, printable coating in intimate contact with or near one of the facial surfaces of the film, the coating comprising either high surface area filler or a thermoplastic elastomer; and

C. A pressure-sensitive adhesive in intimate contact with or near the other facial surface of the film.

The film typically comprises polyimide or polyester, the coating is typically a phenoxy resin, and the filler is typically a high-surface area silica or mica. The thermoplastic elastomer is typically a hydrocarbon rubber without functional groups, preferably a polyether or polyester type of polyurethane with a glass transition temperature (Tg) of equal to or lower than 32 C.

In another embodiment, the invention is a web comprising a plurality of the labels as described above while in yet another embodiment, the invention is a label as described above on an object.

### BRIEF DESCRIPTION OF THE DRAWINGS

FIG. 1 is a schematic cross-section of a conventional high temperature, thin label.

FIG. 2 is a photograph comparing thin labels of this invention with a conventional thin label.

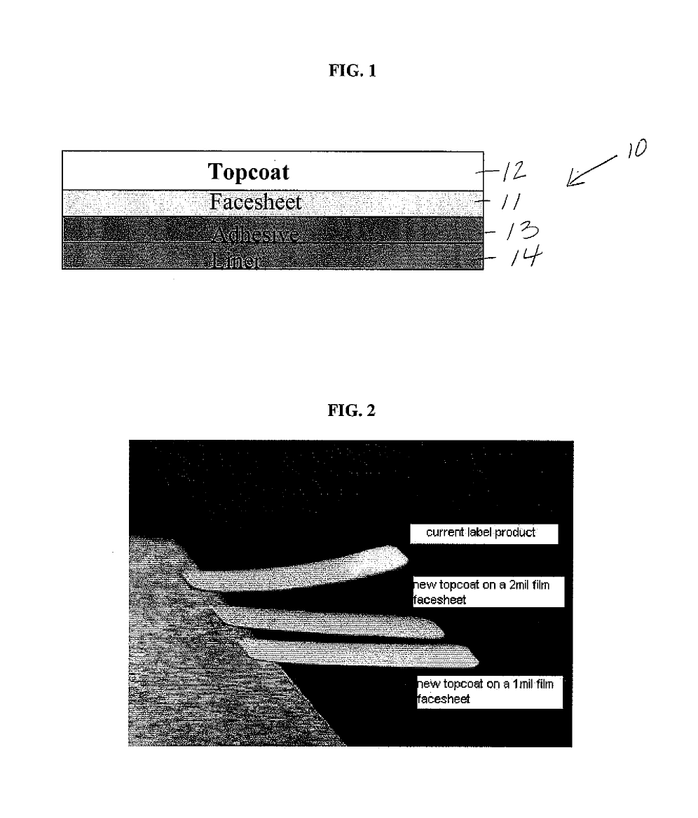

### DESCRIPTION OF THE PREFERRED EMBODIMENT

The numerical ranges in this disclosure include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, thickness of the thin label and/or its various layers, surface areas, coating formulations, and the like.

“Facial surface”, “planar surface” and like terms is used in distinction to “edge surface”. If rectangular in shape or configuration, a label will comprise two opposing facial surfaces joined by four edge surfaces (two opposing pairs of edge surfaces, each pair intersecting the other pair at right angles). In a conventional three-layer label, the first facial surface of the film receives the top coating and the second facial surface receives the adhesive. The labels can be of any size and shape and as such, so can the facial and edge surfaces, e.g., thin or thick, polygonal or circular, flat or wavy, etc.

“Label” and like terms means an article of identification for attachment to an object. In the context of this invention, a label comprises multiple layers, typically three or more. The top layer is a coating adapted to receive an ink-image, e.g., serial number, bar code, etc., from a printer or other image-delivering device. The middle layer is a film to provide strength and substance to the label, and surfaces to which the top coat and adhesive can attach. The bottom or base layer is an adhesive for providing a means to attach the label to the object. The bottom or adhesive layer is usually covered by a protective release liner until the label is ready for attachment to the object. The label can comprise other layers over either or both the top coat and adhesive, and/or intermediate to the top coat and film and/or the adhesive and film.

“Thin label” and like terms means that the label has a thickness of less than 127, preferably less than 102 and more preferably less than 76, microns (μm).

“Curl”, “label curl” and similar terms mean a label that bends up or down relative to a flat surface.

“Layer” means a single thickness, coating or stratum spread out or covering a surface.

“Multi-layer” means at least three layers.

“In intimate contact” means that one planar surface of one layer and one planar surface of another layer, or the adhesive layer of a label and the exterior surface of an object or substrate to which the adhesive layer of the label is applied, are in an adhering relationship to one another such as a coating is in an adhering relationship with the substrate to which it is applied.

“In intimate contact with or near one of the facial surfaces of the film” and like terms means that a layer is either in intimate contact (as defined above) with a facial surface of another layer, or that one layer is removed from a facial surface by one or more intermediate layers.

The films used in the practice of this invention can be made of any material that exhibits good mechanical strength and heat resistance, e.g. polyimide, polyester, polyetherimide (PEI), polyethylene naphthalate (PEN), polyether sulfone (PES), polysulfone, polymethylpentene (PMP), polyvinylidene fluoride (PVDF), ethylene-chlorotrifluoroethylene (ECTFE), etc. These films are typically between 0.5 and 5, preferably between 0.75 and 2, mils in thickness. Films made of polyimide, e.g., Kapton® available from DuPont, Apical® available from Kaneka Texas Corporation; or polyester, e.g. Mylar® available from DuPont, 2600 polyethylene terephthalate film available from American Hoechst, etc.; or PEI, e.g., Tempalux™ available from Westlake Plastics Company, Superio-UT™ available from Mitsubishi Plastics, etc.; or PEN, e.g., Kaladex™ and Teonex both available from DuPont, are preferred. Other useful polymer films include such films compounded with property modifying agents such as those known in the film art; as well as surface treated or coated films of such polymers, treated, for example, to make them more ink receptive.

The adhesive layer can comprise any adhesive that is effective in binding the label to an external surface of the object to which the label is affixed as long as the adhesive exhibits good heat resistance and peel strength. Preferably, but not necessarily, the adhesive also exhibits cohesive strength and high shear resistance. An aggressive pressure sensitive adhesive is preferred, such as one of the high-strength or rubber-modified acrylic pressure sensitive adhesives, such as Duro-Tak® 80-115A available from National Starch and Chemical Co. or Aroset™ 1860-Z-45 available from Ashland Specialty Chemical Company. Preferred pressure sensitive adhesives include copolymers of alkyl acrylates that have a straight chain of from 4 to 12 carbon atoms and a minor proportion of a highly polar copolymerizable monomer such as acrylic acid. These adhesives are more fully described in U.S. Pat. Re. 24,906 and U.S. Pat. No. 2,973,286. Alternative pressure sensitive adhesives include ultraviolet curable pressure sensitive adhesives such as Duro-Tak 4000 that is available from National Starch and Chemical Co.

Optionally, and preferably, the labels include a release liner that is adjacent to and in intimate contact with the layer comprising the adhesive to protect the adhesive before the label is applied to an object or substrate, e.g., during manufacture, printing, shipping and storage. Typical and commercially available release liners comprise a silicone-treated release paper or film, and are available from Loparex (products such as 1011, 22533 and 11404), CP Films and Akrosil™.

Print, i.e., information in the form of words, numbers, designs, code bars or other forms of human or machine readable graphics, is typically applied to the first surface of the first layer of the label, e.g., the surface open to the environment. The first layer in this invention is the top coat layer, and the print can be applied by any one of a number of different conventional processes, e.g., flexographic, letterpress, screen, gravure and photographic printing. For print-on-demand applications, a thermal transfer process typically applies the print although other methods can be used such as dot matrix printing or ink jet printing. For pre-print applications, ultraviolet, aqueous or solvent inks are typically used. The information can be applied before or after assembly of the complete label although it is typically applied after the label has been completely assembled. The chemical composition of the ink or other substance employed to print the information is not critical, but it must produce a printed pattern that adheres sufficiently to the top surface of the top coat to which it is applied to allow for a reasonable degree of permanency.

The composition of the top coat can vary to convenience, and any suitable crosslinkable, film-forming, solvent-soluble phenoxy resin may be employed as the top coat for the labels of this invention. The coating may comprise one or more layers of different materials so long as the outermost layer comprises the crosslinked phenoxy resin. Phenoxy resins are well known in the art and are also referred to as poly(bisphenol A-co epichlorohydrin). Since poly(bisphenol A-co epichlorohydrin) contains pendant hydroxyl groups, they are crosslinkable by any of various materials, e.g., melamines, isocyanates, phenolics, urea-formaldehydes and the like, which are reactive with hydroxyl groups in the presence of a catalyst such as dibutyl tin dilaurate. The phenoxy resins described in U.S. Pat. Nos. 6,261,730, 4,578,312 and 4,526,912 are representative. Typically and preferably, the phenoxy resin is crosslinked with an isocyanate or melamine crosslinker. Crosslinking is typically and preferably effected by homogeneously mixing the crosslinker and the catalyst with the phenoxy resin, coating the mixture onto one facial surface of the film, and then exposing the coated film to crosslinking conditions, e.g., heat, radiation, etc.

The stress-relieving agent or filler is either high surface area filler or a thermoplastic elastomer. “High surface area” means that the filler has a surface area of at least 5, preferably at least 100 and more preferably at least 200, m²/g as measured by the BET method as described by S. Brunauer, P. H. Emmett and E. Teller, J. Am. Chem. Soc., 1938, 60, 309. Preferred filler particles are silica and mica, preferably amorphous silica, for example, a micronized gel or precipitated silica, most preferably a micronized silica gel. The volume weighted mean particle diameter defined as D[4,3] according to M. Alderliesten, Part. Part. Syst. Charact., 8, (1991), p. 237, of the silica particles incorporated into the top coat layer ranges from 1 to 10 micrometers. The silica particles have an average surface area of from 5 to 1,000, preferably from 100 to 900 and more preferably from 200 to 800, m²/g.

The actual particle size of 99.9% by volume of the silica or mica particles typically does not exceed 16 micrometers (μm), preferably 13 μm and most preferably it does not exceed 10 μm. Preferably, the ratio d75/d25 for the silica or mica particles is within the range of from 1.3 to 2.1. The particle size distribution of the silica or mica is preferably measured in water using a Coulter LS230 instrument.

The addition of the silica or mica acts like a diluent in the crosslinked topcoat network, and thus reduces the shrinkage of the topcoat and reduces or eliminates the curling of the label. In order to obtain these advantageous anti-curl properties, the weight ratio of silica or mica to phenoxy resin is between 0.005/100 to 5/100, preferably between 0.01/100 to 5/100 and more preferably between 0.1/100 to 3/100.

The thermoplastic elastomers, which are chemically compatible with the phenoxy resins, are typically and preferably polyether or polyester type polyurethanes with a glass transition temperature (Tg) of equal to or lower than 32 C. Examples include the ESTANE® resins available from Lubrizol Advanced Materials, Inc., Morthane® resins available from Huntsman, and Qthan® resins available from K. J. Quinn & Company Inc. For water-based phenoxy resins, water-soluble polyether oxide (PEO) with a Tg of −60 C. available from Deekay Trading Co. and poly(vinyl methyl ether) (PVME) with a Tg of −34 C. available from Polysciences Inc., are exemplary.

The addition of the thermoplastic elastomer acts like a diluent in the crosslinked topcoat network, and thus reduces the shrinkage of the topcoat and reduces or eliminates the curling of the label. In order to obtain these advantageous anti-curl properties, the weight ratio of thermoplastic elastomer to phenoxy resin is between 1/100 to 1/1, preferably between 1/10 to 1/2 and more preferably between 1/5 to 2/5.

The top coats of this invention can further comprise one or more fillers and/or additives. These materials are added in known amounts using conventional equipment and techniques. Representative fillers include tale, calcium carbonate, organo-clay, glass fibers, marble dust, cement dust, feldspar, silica or glass, fumed silica, silicates, alumina, various phosphorus compounds, ammonium bromide, titanium dioxide, antimony trioxide, antimony trioxide, zinc oxide, zinc borate, barium sulfate, silicones, aluminum silicate, calcium silicate, glass microspheres, chalk, mica, clays, wollastonite, ammonium octamolybdate, intumescent compounds and mixtures of two or more of these materials. The fillers may carry or contain various surface coatings or treatments, such as silanes, fatty acids, and the like. Still other fillers include flame retardants such as the halogenated organic compounds.

The top coats can also contain additives such as, for example, pigment dispersant (e.g., Nuosperse® 657 available from Elementis Specialties), colorants or pigments to the extent that they do not interfere with desired loadings and/or physical or mechanical properties of the top coats of the present invention.

The following examples illustrate various embodiments of this invention. All parts and percentages are by weight unless otherwise indicated.

### SPECIFIC EMBODIMENTS

### Example 1

A high-heat resistant, flat, thin label was prepared by coating a polyimide facesheet with a top coat prepared from the following formulation:

TABLE 1
Top Coat Composition

| | Inventive | Comparative |
|---|---|---|
| | Flat Coating | Coating |
| Formulation Component | Amount in Grams | Amount in Grams |
| TiO₂ | 20.5 | 21 |
| PKHH Phenoxy Resin | 21 | 26.5 |
| Cyclohexanone | 50 | 50 |
| Estane ® 5307 | 6 | 0 |
| (Thermoplastic Elastomer) | | |
| Nuosperse^{R} 657 (Mineral Spirits) | 0.5 | 0.5 |
| Polyisocyanate Desmodur | 2 | 2 |
| N-75) | | |
| Dibutyltin Dilaurate | 0.05 | 0.05 |

All label samples (including those of Table 4) comprised a pressure sensitive adhesive layer of Duro-Tak®80-115A at 43 microns thickness. The label samples were 6.35 mm in height and 19.05 mm in length, and were placed on a thin aluminum panel for 20 minutes. The panels with label samples were then placed into a preheated oven at the temperatures reported in Table 2 for 5 minutes. The panels were removed from the oven after 5 minutes, and cooled at and to room temperature.

TABLE 2
Heat Resistance Testing Results of Topcoat Composition of Table 1

| Temperature Exposure | Test Result | Test Result |
|---|---|---|
| for 5 Minutes in ° C. | Inventive Flat Coating | Comparative Coating |
| 220 | No Visible Effect | No Visible Effect |
| 240 | No Visible Effect | No Visible Effect |
| 260 | No Visible Effect | No Visible Effect |
| 280 | No Visible Effect | Slight Edge Lifting |
| 300 | Slight Yellowing | Slight Yellowing |
| | | Moderate Edge Lifting |
| 320 | Yellowing | Yellowing |
| | | Severe Edge Lifting |

TABLE 3
Curl Testing Results of Topcoat Composition of Table 1*

| Label Samples | |
|---|---|
| (size 0.75″ × 0.25″, 19.05 mm × 6.35 mm) | Curl test result (mm) |
| Comparative top coat on a 2 mil film facesheet^{±} | 4.2 |
| Flat top coat on a 2 mil film facesheet | 0.1 |
| Flat top coat on a 1 mil film facesheet | 0.4 |

*The curl testing is performed on a digital curl tester made by Brady Corporation.
^{±}Composition of the comparative top coat is reported in Table 1.

Table 3 and FIG. 2 show the difference in curl between the conventional, high-heat resistant thin labels and the labels of this invention. The conventional label is visibly curled in the direction of the coating while the two labels bearing a top coat of formulation 1 exhibit little, if any, curl.

### Example 2

The topcoat composition can be a phenoxy resin based coating system with the addition of any type of silica. The procedure of Example 1 was repeated except with the top coat formulation reported in Table 4. The silica used in this example was a synthetic, amorphous silica, Sylysia® 350 with an average particle size of 3.5 to 4.3 microns and an average surface area of 290 m²/g and available from Fuji Silysia Chemical Ltd.

TABLE 4
Top Coat Composition

| Formulation Component | Amount in Grams |
|---|---|
| TiO₂ | 20 |
| PKHH Phenoxy Resin | 26 |
| Cyclohexanone | 50 |
| Silica | 0.8 |
| Nuosperse^{R} 657 (Mineral | 0.5 |
| Spirits) | |
| Polyisocyanate Desmodur | 2 |
| N-75) | |
| Dibutyltin Dilaurate | 0.05 |

The labels were tested for curl in the same manner as were the labels of Example 1.

TABLE 5
Heat Resistance Testing Results of Topcoat Composition of Table 4

| Temperature Exposure | |
|---|---|
| for 5 Minutes in ° C. | Test Result |
| 220 | No Visible Effect |
| 240 | No Visible Effect |
| 260 | No Visible Effect |
| 280 | No Visible Effect |
| 300 | Slight Yellowing |
| 320 | Yellowing |

TABLE 6
Curl Testing Results of Topcoat Composition of Table 4*

| Label Samples | |
|---|---|
| (size 0.75″ × 0.25″, 19.05 mm × 6.35 mm) | Curl test result (mm) |
| Comparative top coat on a 2 mil film facesheet^{±} | 4.2 |
| Flat top coat on a 2 mil film facesheet | 0.3 |
| Flat top coat on a 1 mil film facesheet | 0.5 |

*The curl testing is performed on a digital curl tester made by Brady Corporation.
^{±}Composition of the comparative top coat is reported in Table 1.

Similar to the results of Example 1, the labels of this example exhibit only minimal, trivial curl while the conventional label exhibits an order of magnitude more curl.

### Example 3

The topcoat composition can be a phenoxy resin based coating system with the addition both a thermoplastic elastomer and silica. The combination of the two stress-reducing agents reduces the shrinkage of the topcoat and reduces or eliminates the curling of the label. The procedure of Example 1 was repeated except with the top coat formulation reported in Table 7.

TABLE 7
Top Coat Composition

| Formulation Component | Amount in Grams |
|---|---|
| TiO₂ | 20 |
| PKHH Phenoxy Resin | 20 |
| Cyclohexanone | 50 |
| Estane ® 5307 (Thermoplastic | 6 |
| Elastomer) | |
| Silica | 1 |
| Nuosperse^{R} 657 (Mineral | 0.5 |
| Spirits) | |
| Polyisocyanate Desmodur | 2 |
| N-75) | |
| Dibutyltin Dilaurate | 0.05 |

The labels were tested for curl in the same manner as were the labels of Example 1.

TABLE 8
Heat Resistance Testing Results of Topcoat Composition of Table 7

| Temperature Exposure | |
|---|---|
| for 5 Minutes in ° C. | Test Result |
| 220 | No Visible Effect |
| 240 | No Visible Effect |
| 260 | No Visible Effect |
| 280 | No Visible Effect |
| 300 | Slight Yellowing |
| 320 | Yellowing |

TABLE 9
Curl Testing Results of Topcoat Composition of Table 7*

| Label Samples | |
|---|---|
| (size 0.75″ × 0.25″, 19.05 mm × 6.35 mm) | Curl test result (mm) |
| Comparative top coat on a 2 mil film facesheet^{±} | 4.2 |
| Flat top coat on a 2 mil film facesheet | −0.04 |
| Flat top coat on a 1 mil film facesheet | −0.07 |

*The curl testing is performed on a digital curl tester made by Brady Corporation.
^{±}Composition of the comparative top coat is reported in Table 1.

Similar to the results of Examples 1 and 2, the labels of this example exhibit only minimal, trivial curl while the conventional label exhibits an order of magnitude more curl. The negative numbers indicates that the curl is so insignificant as to be virtually not noticeable to the naked eye and less than the testing error.

Although the invention has been described in considerable detail, this detail is for the purpose of illustration and is not to be construed as a limitation on the scope of the invention as described in the pending claims. All U.S. patents and published patent applications identified above are incorporated herein by reference.

What is claimed is:

1. A high-heat, curl-resistant thin label comprising:
A. A film having first and second facial surfaces;
B. A crosslinked, printable coating in intimate contact with or near one of the facial surfaces of the film, the coating comprising either high surface area filler or a thermoplastic elastomer; and
C. A pressure-sensitive adhesive in intimate contact with or near the other facial surface of the film.

2. The label of claim 1 in which the film comprises at least one of polyimide, polyester, polyetherimide (PEI), polyethylene naphthalate (PEN), polyether sulfone (PES), polysulfone, polymethylpentene (PMP), polyvinylidene fluoride (PVDF), and ethylene-chlorotrifluoroethylene (ECTFE).

3. The label of claim 1 in which the film comprises a polyimide or polyester.

4. The label of claim 3 in which the crosslinked, thermal transfer printable coating comprises a phenoxy resin.

5. The label of claim 4 in which the phenoxy resin is crosslinked with an isocyanate or melamine crosslinker.

6. The label of claim 5 in which the high surface area filler is at least one of silica and mica.

7. The label of claim 6 in which the silica or mica has a surface area of at least 5 m²/g as measured by the BET method.

8. The label of claim 7 in which the silica or mica is present in a silica or mica to phenoxy resin weight ratio of between 0.005 to 100 and 5 to 100.

9. The label of claim 1 in which the thermoplastic elastomer is a polyether or polyester type of polyurethane.

10. The label of claim 9 in which the thermoplastic elastomer is present in an elastomer to phenoxy resin weight ratio of between 1 to 100 and 1 to 1.

11. A web comprising a plurality of the labels of claim 1.

12. An object bearing a label of claim 1.
